(19) United States
(12) Patent Application Publication
(10) Pub. No.: US 2015/0127309 A1
(43) Pub. Date: May 7, 2015

(54) Method To Translate Biodynamic Spectrograms Into High-Content Information

(71) Applicant: Purdue Research Foundation, West Lafayette, IN (US)

(72) Inventors: Ran Am, West Lafayette, IN (US); David D. Nolte, Lafayette, IN (US); John J. Turek, West Lafayette, IN (US)

(21) Appl. No.: 14/527,297

(22) Filed: Oct. 29, 2014

Related U.S. Application Data
(60) Provisional application No. 61/896,732, filed on Oct. 29, 2013.

(51) Int. Cl. G06F 19/12; G06F 17/18

(52) U.S. Cl. CPC G06F 19/12; G06F 17/18
USPC 703/2

(57) ABSTRACT

A method is provided to translate from tissue dynamics spectroscopy (TDS) data formats into high-content analysis (HCA) data formats. The method utilizes TDS feature vectors and HCA feature vectors obtained from a shared set of compounds and cell lines to generate a translation matrix. The translator is applied to the unique data format of TDS that carries information from deep inside 3D tissue to convert the data into a standard data 2D HCA data format that fits into the standard workflow of potential customers.

### PRIORITY CLAIM AND REFERENCE TO RELATED APPLICATION

This application is a utility application of and claims priority to co-pending provisional application No. 61/896,732, filed on Oct. 29, 2013, the entire disclosure of which is incorporated herein by reference.

### STATEMENT OF GOVERNMENT INTEREST

This invention was made with government support under CBET1263753 awarded by the National Science Foundation. The government has certain rights in the invention.

### BACKGROUND

In early drug discovery, high-content screening is a mainstream approach that uses high-resolution imaging techniques and fluorescent dyes to acquire information-rich images of cells on two-dimensional slides [1-3]. (It is noted that the bracketed numbers refer to publications listed in the Appendix to this specification). High-content screening and high-content analysis of the images yields micro-scale and targeted information about the action of the drug on the cells. Information such as cell shape, membrane integrity, mitochondrial membrane polarization, ATP concentrations, cytoskeletal structure, organelle density, nuclear shape, nuclear membrane integrity, among many other possibilities are extracted by the high-content analysis. Because many of the dyes or fluorophores are targeted at molecular targets, the information can be molecularly specific [4-6].

For the past decade the major pharmaceutical companies have invested heavily in target-based drug discovery, but with disappointing returns and fewer-than-expected discoveries (with some notable exceptions like Gleevec [7, 8]). Target-based drug discovery is a bottom-up approach that starts with specific molecular targets in signaling pathways and develops drugs that enhance or inhibit that target to produce desired downstream effects. The greatest problem with this approach is the probability of off-target effects of the drug that ultimately prevent its clinical use.

The opposite of target-based drug discovery is phenotypic profiling that measures the broad-spectrum cellular response to drugs. In a recent study of all drugs approved by the FDA since 1999, it was found that ⅔ of those approved were developed through phenotypic profiling and only ⅓ by target-based approaches [9]. Two-dimensional monolayer cultures are the current industry standard for phenotypic profiling. But the deficiencies of this approach are well known, such as the wrong dimensionality, the wrong cell shapes, and the subsequent modified biochemistries that are not representative of natural tissues and that lead to non-representative drug responses [10, 11].

Despite the high information content that can be extracted from high-resolution microscopy images, pharmaceutical screening in two-dimensional cell culture format has reached a barrier to further progress. Biology is an intrinsically three-dimensional phenomenon, with cells in tissues having essential three-dimensional environments [11-22]. The three-dimensional environmental context is lost in two-dimensional cell culture and monolayers, which modifies cellular response to applied drugs. It is now known that cells in 2D do not behave as cells in 3D tissues, with different genetic expression profiles [23-25], different intercellular signaling [26-29], and different forces attaching them to their environment [30-32]. Therefore, understanding relevant biological functions requires the capture of dynamical processes and motions in three dimensions. The challenge has been to find an imaging technique that is optimally sensitive to motion instead of (or in addition to) structure, and that also is able to extract information from inside tissue far from surfaces.

Holographic optical coherence-domain imaging (OCI) provides the required depth capability [33, 34], motility contrast imaging (MCI) provides the sensitivity to cellular motions [35, 36], and tissue dynamics spectroscopy (TDS) and tissue dynamics imaging (TDI) provides signatures of dynamic cellular functions [37, 38]. The holographic capture of depth-resolved images from optically-thick live tissues has evolved through several stages, from optical coherence imaging (OCI) to motility contrast imaging (MCI) and fluctuation spectroscopy (TDS) and now to tissue dynamics imaging (TDI) as disclosed herein.

Optical coherence imaging uses coherence-gated holography to optically section tissue up to 1 mm deep [39, 40]. It is a full-frame imaging approach, closely related to en face optical coherence tomography [41, 42], but relies on high-contrast speckle to provide high sensitivity to motion [43]. The first implementations of OCI used holographic recording media [44] such as photorefractive quantum wells [45] to capture the coherent backscatter and separate it from the diffuse background. Digital holography [46-49] replaced the recording media and has become the mainstay of current implementations of OCI [50]. Highly-dynamic speckle was observed in OCI of living tissues caused by intracellular motions [35], and was used directly as an endogenous imaging contrast in motility contrast imaging that could track the effects of antimitotic drugs on tissue health [36]. A system for holographic OCT is described in co-pending U.S. application Ser. No. 12/874,855, published on Dec. 30, 2010, as Pub. No. 2010/0331672, entitled “Method and Apparatus for Motility Contrast Imaging”, and in co-pending U.S. application Ser. No. 13/704,464, published on Apr. 18, 2013, as Pub. No. 2013/0088568, entitled “Digital Holographic method of Measuring Cellular Activity and of Using Results to Screen Compounds”. The disclosures of both applications are incorporated herein by reference in their entirety.

Motility contrast imaging is a form of dynamic light scattering (DLS) in tissues. DLS is performed as quasi-elastic light scattering (QELS) when light is predominantly singly-scattered, and as diffusing-wave spectroscopy (DWS) [51, 52] or diffusing correlation spectroscopy (DCS) [53] when light is multiply scattered. QELS has been applied mainly to single cells or monolayer cultures to study motion in the nucleus [54], the cytosol [55], cell motion [56] and membrane fluctuations [57]. DWS and DCS probe deeply into tissue and have been used to study actin filament networks [58], imaging dynamic heterogeneities [59], and brain activity [60]. Systems and methods for performing motility contrast imaging are described in co-pending application Ser. No. 12/874,855, entitled “Method and Apparatus for Motility Contrast Imaging”, already incorporated herein by reference above.

A key question concerning the drug-response spectrograms obtained by biodynamic imaging is how much information is contained in these spectrogram data structures. There are many types of intracellular motions, including organelle transport, endo- and exo-cytosis, membrane undulations, cytoplasmic streaming, cytoskeletal rearrangements, force relaxation and shape changes, among others. While general trends in the spectrograms are understood in terms of these types of motion, it is necessary to establish how much information can be obtained from tissue dynamics spectroscopy. In addition, most of the work-flow of the pharmaceutical industry in early drug discovery is expressed in the language of microscopic high-content screening and analysis. Therefore, while biodynamic imaging extracts high information content from three-dimensional tissue, it has not been expressed in the same data format (or language) that is required to make decisions on lead selection in drug discovery.

### SUMMARY

A method is provided for translating tissue dynamics spectrograms from biodynamic imaging into the language of high-content analysis that is suitable for decision making in lead selection. In one aspect, the method includes collecting conventional high-content data in tandem with 3-D tissue-dynamics spectrograms and then creating a functional translator matrix that produces conventional high-content data using the 3-D biodynamic data as input.

### DESCRIPTION OF THE FIGURES

FIG. 1 is a diagram depicting the conceptual relationship between physiological processes and laboratory measurements, in which the measurements can be conventional high-content analysis data or biodynamic data.

FIG. 2 is a graph of the correlation coefficient between high-content analysis feature vectors and biodynamic imaging feature vectors generated by numerical simulation showing the correlations as a function of a “coherent fraction” of features that are shared between HCA and TDS.

FIG. 3 is a graph of correlation as a function of the number of compounds in a training set implementing the matrix approach to translation depicted in FIG. 1.

FIG. 4A is a time-frequency spectrogram dataset obtained by tissue dynamics spectroscopy for a particular drug response.

FIG. 4B are time-frequency masks to project the spectrogram of FIG. 4A into a feature vector shown in FIG. 4C.

FIG. 4C is a depiction of a feature vector formed by the projection of the masks of FIG. 4B onto the spectrogram of FIG. 4A.

FIG. 5 is hierarchically clustered feature vector and associated similarity matrix for a plurality of drug responses.

FIG. 6 is a map of joint feature vectors for a plurality of drug compounds for two cell lines, for a single tissue dynamics spectroscopy (TDS) concentration with phenotypic profile twelve features, and three high-content analysis (HCA) concentrations and seven features, in which each row corresponds to a feature and each column corresponds to a drug compound.

FIG. 7 is a map of an averaged, or partial trace, density matrix connecting the TDS features with the HCS features shown in FIG. 6.

FIG. 8 is graph of experimentally derived correlation coefficients for a plurality of drug responses of two cell lines, DLD-1 and HT-29.

FIG. 9 are linear superpositions of TDS masks having the strongest correlation with specific HCA properties, from which the resulting patterns are presented as artificial time-frequency spectrograms representative of the specific HCA features.

### DETAILED DESCRIPTION

Informatics Methodology

Phenotypic Vector Spaces

A phenotypic profile includes a vector array of quantitative measurements of a number of properties or features of cells or tissues responding to an applied stimulus

|Vⁱ>; i=1:P

where |Vⁱ> is the i-th component of the feature vector with the index varying from 1 to P for P features. The symbolic notation in the expression combines bracket notation with contravariant vector notation. The index i that appears as a superscript denotes a column (contravariant) vector with contravariant row index i. The transpose of the foregoing equation is a row (covariant) vector denoted as <Vⁱ| with covariant column index i. The bracket notation is borrowed from quantum mechanical theory because it provides a transparent way of constructing projection operators that will be used to project from one phenotypic space to another. The contravariant-covariant notation is borrowed from tensor analysis because it makes it easy to denote inner and outer products of vectors to construct the projection operator.

In high-content drug screening, the properties i=1:P can relate to morphological properties of cellular constituents, to densities, to functional properties such as mitochondrial membrane polarization, and to dynamic behavior, among others. The dimension of the phenotypic vector space is equal to the number of properties P. A phenotypic panel includes a set of feature vectors obtained across a panel of compounds or conditions

|Vₘⁱ>; m=1:M

for the index m varying from 1 to M compounds or conditions. The values of |Vₘⁱ> are usually arranged as M column vectors of length P, e.g., as a P by M matrix.

The feature vector space has dimension P, but the coordinate axes are not orthogonal. In other words, the features are not in general independent and have correlations among them. For instance, the covariance matrix for a phenotypic panel |Vₘⁱ> is given by

$${C}_{j}^{i} = {\sum }_{m = 1}^{M} 〈 ( {V}_{j}^{m} - {μ}_{j} ) \vert ( {V}_{m}^{i} - {μ}^{i} ) 〉$$

where the μᵢ are the mean values of the i-th feature averaged across the conditions indexed by m. The off-diagonal terms of the covariance matrix are in general non-zero. The covariance matrix participates in multivariate statistical analyses such as principal component analysis and canonical correlation analysis. It is central to the process of dimensionality reduction by helping to identify the smallest number of properties, or combinations of properties, that capture most of the independent behaviors of the system.

Density Matrix

Features measured by high-content image analysis of 2D culture are substantially different than the features obtained from tissue dynamics spectroscopy (TDS). Furthermore, the experimental conditions are very different. In the case of high-content analysis (HCA), individual cells on plates are imaged using fluorophores specific to the nucleus and mitochondria. In the case of TDS, on the other hand, the cells are within tissues, and intracellular motions constitute the label-free imaging contrast. Both techniques measure physiological properties of the cells and tissues responding to the applied compounds. Therefore, it is important to explore whether HCA and TDS features relate to the same physiological processes.

The feature vectors for HCA are expressed as |Vₘ^{a}> and for TDS as |Vₘ^{b}> where the index m spans across M compounds. The dimension of the HCA space is A, and the dimension of the TDS space is B. The feature vectors are used to construct a projection operator, also known as a density matrix, which projects from one space to another and back. The projection operator that projects from the TDS space to the HCA space is

{\hat{p}_{b}^{a}}ₘ=|Vₘ^{a}><V_{b}^{m}|

for the compound m. This A-by-B dimensional matrix is the outer product of the HCA and the TDS feature vector for the m^{th} compound. The goal is to find a mapping that is consistent across a broad selection of compounds, and ideally across several cell lines. To construct an average mapping, a reduced projection operator is generated as the partial trace over the compounds

$${\hat{ρ}}_{b}^{a} = {Tr}_{m} {\{ {\hat{ρ}}_{b}^{a} \}}_{m} = \frac{1}{M} {\sum }_{m = 1}^{M} {\{ {\hat{ρ}}_{b}^{a} \}}_{m}$$

The reduced density matrix \hat{p}_{b}^{a} is the desired translation (or projection) matrix between the TDS and the HCA spaces.

Back-Projection Method

For a given compound m that has a TDS feature vector |Vₘ^{b}> the back-projected HCA feature vector |Vₘ^{a}> for that compound is projected to be

|Vₘ^{a}>=\hat{p}_{b}^{a}|Vₘ^{b}>

This can be applied to each compound m to reconstruct the A-by-M matrix of HCA feature vectors. In this last equation, the reduced projection operator is the general mapping that translates the TDS feature vector into a corresponding HCA feature vector. In general, back-projection maps a higher-dimensional space to a lower-dimensional space such that B>A when the dimension of the TDS space is larger than the dimension of the HCA space.

The projection operator approach is strictly accurate only if there is a unique projection from one space to the other. However, in biological phenotypic assays, there may be features in one assay that are missed by the other, and there are often strong correlations among features within an assay. Therefore, the projection operator approach must be incomplete when translating between two assay formats, as between TDS and HCA. The question then arises how faithfully the translation matrix captures the relationships between the two assays.

Theoretical Basis of Phenotypic Back-Projection

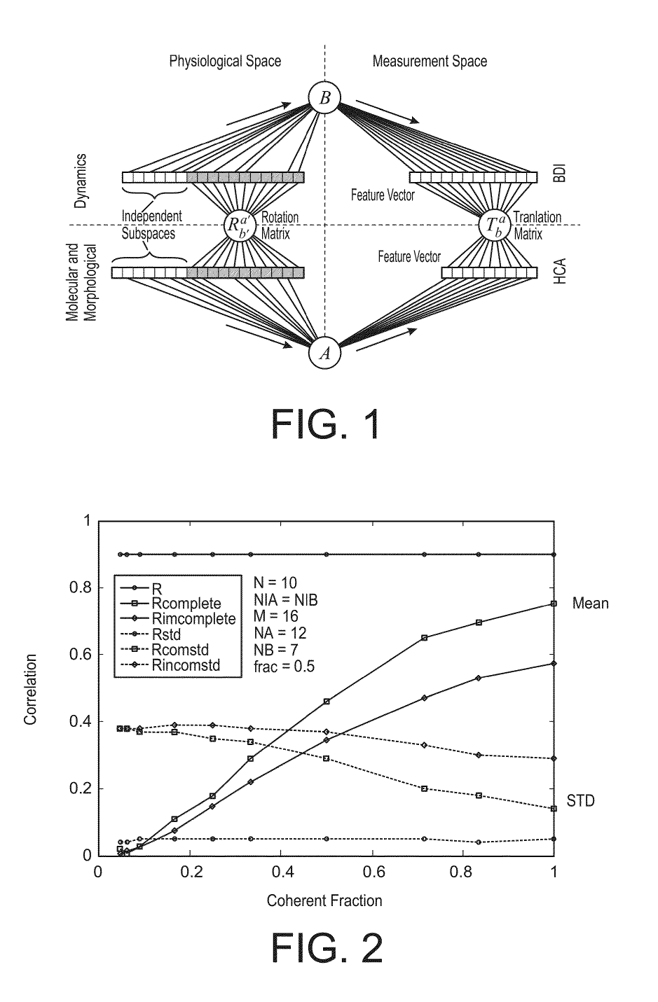

The theoretical basis of the method disclosed herein for translating from biodynamic imaging spectrograms to conventional high-content data formats is depicted schematically in FIG. 1. The method seeks to project from physiological space to measurement space. Two independent measurement techniques are used to probe the physiological space: a 2D imaging approach that measures the microscopic physiological properties of the sample (HCA), and a 3D dynamic approach that measures the intracellular dynamics (BDI). It is assumed that the physiology subspace and the dynamics subspaces have a correspondence or correlation among a number N_{D} features. Furthermore, because dynamics and morphology are not identical, there are additional subspaces for dynamics with N_{DI} features and for morphology with N_{MI} that are independent of each other. The correspondence between the dependent subspaces is denoted by a generalized rotation matrix R that “scrambles” the dependent feature sets.

The specific experimental details of BDI and HCA convert the features of physiological space into measurement features. This is represented by a generalized rotation matrix B for BDI and A for HCA. These transformations take, as input, features from both the dependent and independent spaces. Depending on what is measured, not all features from the physiological space are sampled. The resultant of these transformations is a measured set of dynamic features and a measured set of morphological or molecular features. Because of the correspondence of some of the features in physiological space through the transformation R, there is a correspondence among the measured feature vectors represented by the translation matrix T. The goal of the method disclosed herein is to determine the translation matrix T that allows translation from the BDI feature vectors to HCA feature vectors that fit into the work-flow and decision-making of lead selection in drug discovery.

To test the fidelity of the back-projection, consider two subspaces of eigenvectors for each of |Vₘ^{a}> and |Vₘ^{b}>. One subspace is the dependent subspace in which as |Vₘ^{a′}> and |Vₘ^{b′}> are related through the real-valued unitary rotation operator R_{b′}^{a′}

|Vₘ^{a′}>=R_{b′}^{a′}|Vₘ^{b′}>

The second subspace is independent, denoted by double-primed indices, and have no correlations between |Vₘ^{a″}> and |Vₘ^{b″}>, such that

$${\sum }_{m = 1}^{M} 〈 {V}_{{b}^{′}}^{m} \vert {V}_{m}^{{a}^{′}} 〉 = {R}_{{b}^{′}}^{{a}^{′}} \\ {\sum }_{m = 1}^{M} 〈 {V}_{{b}^{″}}^{m} \vert {V}_{m}^{{a}^{′}} 〉 = O ( 1 / \sqrt{M} ) \\ {\sum }_{m = 1}^{M} 〈 {V}_{{b}^{′}}^{m} \vert {V}_{m}^{{a}^{″}} 〉 = O ( 1 / \sqrt{M} ) \\ {\sum }_{m = 1}^{M} 〈 {V}_{{b}^{″}}^{m} \vert {V}_{m}^{{a}^{″}} 〉 = O ( 1 / \sqrt{M} ) \qquad Equations 1$$

where the average is over many compounds or conditions denoted by the index m. The first term is the rotation matrix. The other three terms have residual non-zero values that are of order (1/\sqrt{M}) which reflects the random and independent character of the subspaces. (Note: all vectors must be zero-averaged and normalized for this square root dependence).

The observables for |Vₘ^{a}> and |Vₘ^{b}> are denoted by superscripts p and q, respectively. The observables are linear combinations of the observables in the dependent and independent subspaces through

a^{p}=Aⱼ^{p}a^{j}

b^{q}=Bₖ^{q}a^{k}

for j={a′, a″} and k={b′, b″} where j spans both the dependent as |Vₘ^{a′}> subspace and the independent as |Vₘ^{a″}> subspace, and k spans the dependent |Vₘ^{b′}> subspace and the independent |Vₘ^{b′}> subspace. The transformations Aⱼ^{p} and Bₖ^{q} are not complete and generally non-invertible. This non-completeness means that not all eigenvectors that span a space are included in the observables (certain responses are missed). Furthermore, the non-invertibility means that some observables carry information that is partially redundant with other observables.

For a compound or condition m, the inner product between feature vectors of the two spaces is

<b_{q}^{m}|aₘ^{p}>=A_{a′}^{p}B_{q}^{b′}<V_{b′}^{m}|Vₘ^{a′}>+A_{a′}^{p}B_{q}^{b′}<V_{b″}^{m}|Vₘ^{a′}>+A_{a″}^{p}B_{q}^{b′}<V_{b′}^{m}|Vₘ^{a″}>+A_{a″}^{p}B_{q}^{b″}<V_{b″}^{m}|Vₘ^{a″}>

By using the relations in Equations 1 above after summing over a large number M of compounds and conditions, this generates the translation matrix

$${T}_{q}^{p} = {\sum }_{m = 1}^{M} 〈 {b}_{q}^{m} \vert {a}_{m}^{p} 〉 = {A}_{{a}^{′}}^{p} {B}_{q}^{{b}^{′}} {R}_{{b}^{′}}^{{a}^{′}} + O ( \frac{{A}^{″} {B}^{″}}{AB} ) + O ( 1 / \sqrt{M} ) = {\hat{ρ}}_{q}^{p}$$

where the inner products among the non-correlated subspaces vanish to lowest order, and the translation matrix is equal to the reduced density operator. The residuals fall under two types. Random residual correlations are of order O(1/\sqrt{M})). These can be made arbitrarily small by averaging over a large set of compounds and conditions. The other residual is not random and is related to the size of the independent components A″ and B″ relative to the total sizes A and B of the feature vectors. This residual cannot be reduced by increasing the number M, but depends on the relative contributions of the independent subspaces to the defined feature vector elements.

The translation matrix T_{q}^{p} is not in general unitary, even though R_{b′}^{a′} is unitary, because A_{a′}^{p} and B_{q}^{b′} are not complete and generally may be non-invertible and non-square matrices. If they were complete and invertible, then the translation would have perfect fidelity in the limit that the number of compounds tested M goes to infinity.

However, in the experimental situation between TDS and HCA the fidelity will be less than unity because of the finite number of compounds. The question is: how much less? The fidelity of the translation matrix is defined experimentally as

F=<aₚ|T_{q}^{p}|b^{q}>ₘ

where aₚ and b_{q} are the experimentally measured feature vectors, and T_{q}^{p} is obtained from the experimental correlations. Because the transformations are not complete and generally may be non-invertible, the transformation must be from the larger assay space to the smaller assay space. Since the TDS is larger, the translation matrix is constructed to translate a TDS feature vector into an HCA feature vector.

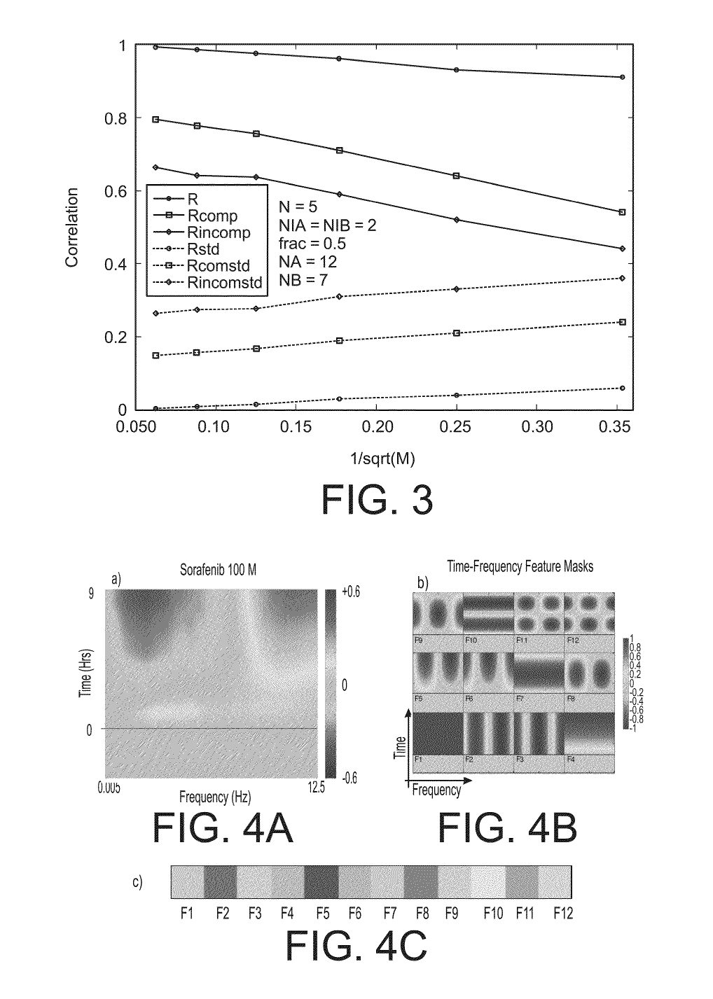

The theoretical model depicted in FIG. 1 was tested using Monte-Carlo computer simulations. An example of the simulation results is shown in FIG. 2. The size of the dependent subspace is N=10, and the sizes of the independent spaces were set equal to each other NIA=NIB. The observable feature size is NA=12 for BDI and NB=7 for HCA, which matches the HCA/TDS experimental conditions described below. The compound set size is M=16, which is also the same as the experimental conditions. The completeness fraction is the fractional subsampling of the full physiological space by the A and B transformations and is given by fraction=0.5 for this simulation. FIG. 2 shows the correlation coefficient between the HCA and the BDI feature vectors as a function of the coherent fraction which is defined by N/(N+NIA). There are three correlation curves on the figure. The curve designated by R at the top of the graph is the “true” correlation when only the dependent a and b subspaces are included. The correlation is less than unity because only M=14 compounds are used in the Monte Carlo simulation. The curve designated by R_{complete} (the second line from the top right of the graph) uses a complete mixture for the transformations A and B and includes the non-orthogonal expansion to NA and NB observables. The correlation coefficient of R_{complete} is less than R because of the non-orthogonal features in the measurement space. The curve designated by R_{incomplete} uses an incomplete mixture for the A and B transformations. In this figure, the incomplete fraction is 50% which reduces it further from R_{complete}. Also shown in FIG. 2 are the standard deviations on the mean values. The mean values only exceed the standard deviation for coherent fractions above 50%. Therefore, in a practical implementation of this method, correlation coefficients larger than 50% can be considered significant. The dependence of the correlations and standard deviations on the number of test compounds M in the training set is shown in FIG. 3 for a coherent fraction of 70% showing the sqrt(M) dependences. Again, a correlation coefficient above 50% is significant.

Materials and Experimental Methods

Cell Lines and Spheroids

HT-29 and DLD-1 cells are products of American Type Culture Collection. DLD1 cells were grown in RPMI-1640 medium with 10% fetal bovine serum. HT-29 cells were grown in McCoy's 5A modified medium. Both cells were grown at 37° C. in a humidified 5% CO₂ atmosphere. To form tumor spheroids [61-63], cells were first grown in cell flasks, then moved to a rotating drum incubator where the cells were suspended in a pure growth medium environment. The medium was refreshed every other day. The cells form optimal experimental size (300 μm-800 μm in diameter) spheroids in the incubator in about 1 week for the DLD-1 cell line and about 4 weeks for the HT-29 cell line.

To perform biodynamic imaging experiments, the tumor spheroids were loaded into S-well Lab-Tek chamber slides (Lab-Tek® II Chamber Slide System). Low-temperature porous agarose was applied to immobilize the tumor spheroids when planted in the chamber slide. The agarose powder from Sigma-Aldrich Inc. was mixed with stock growth medium without serum. The solution concentration was 1% by weight. The agarose solution was first warmed and then cooled to 37° C. The tumor spheroids were moved from the incubator to the chamber slide wells covered with growth medium, then the agarose solution was added to the chamber slide wells and fully mixed. As soon as the agarose gelled, serum and growth medium were added to the wells. Each well contained about 5 to 20 spheroids. The prepared chamber slide was placed on a temperature-stabilized plate on the biodynamic imaging system, and the experiments were performed at 37° C.

Mito Compounds

Mitochondrial dysfunction is a central concern in the development of new drug entities because mitochondrial toxicity is one of the main off-target effects that leads to drug failures in clinical trials [64]. There are many known mitochondrial toxins that work through different mechanisms. Valinomycin is a potassium ionophore that suppresses the mitochondrial membrane potential (MMP) without adversely affecting the viability, while accompanied by an increase in mitochondrial motility [65]. FCCP is a well-studied mitochondrial uncoupler that permeabilizes the mitochondrial membrane to proton transport that also has a minor effect on cellular viability. Nicardipine is a calcium-channel blocking agent that increases the MMP, and decreases intracellular calcium that is accompanied by increased mitochondrial motility [66]. Ionomycin is a potent calcium ionophore that disables MMP accompanied by extinguished mitochondrial motility in astrocytes [67, 68] and cell death. Each of these drugs affects the mitochondria and cellular viability by different mechanisms that are expected to lead to different TDS drug-response signatures.

Raf Kinase Inhibitors

Contrasted to mitochondrial toxins, signaling-pathway inhibitors have more subtle effects on cellular physiology, and many perform as cyotostatic drugs rather than as cytotoxic drugs. Somatic point mutations in BRAF occur in approximately 8% of human tumors [70, 71], and in colon cancer it is as high as 12% [72]. A single glutamic acid for valine substitution at codon 600 (V600E) is present in approximately 90% of BRAF mutations and are associated with poor survival. These patients may be expected to respond to Raf inhibitors [72]. Sorafenib (Nexavar) was the first RAF inhibitor approved by the FDA. However, it is not highly selective to Raf and may operate primarily through anti-angiogenic pathways [73, 74]. PLX4032/RG7204 (Plexikon/Roche) is active against three Raf isoforms at nanomolar concentrations in serum [75-77]. In cells with V600E BRaf mutation, this drug induces cell cycle arrest and sometimes cell death [76]. PLX4032 has minimal toxicity and can be tolerated at serum levels up to 50 μM [78]. PLX4032 has a paradoxical effect on wild-type BRaf, including lines with Ras mutation, in which the Raf inhibitor actually causes activation of ERK in the MAP kinase pathway [79, 80] with similar effects for PLX-4720 [81] and GDC [82]. This would normally require genetic testing of patients to prevent the selection of PLX therapy for cancers that have wild-type BRAF [78], but the development of phenotypic screening methods may provide a fast and inexpensive alternative to genetic testing.

Biodynamic Imaging Experiments

Biodynamic imaging measures intracellular motions by performing digital holography with low-coherence light and capturing the fluctuating intensities of dynamic speckle. It uses a continuous-wave low-coherence light source (Superlum) with a 20 mW output intensity at a wavelength of 840 nm and a bandwidth of 50 nm with a coherence length of approximately 15 microns. The light path is divided into a signal and reference arm in an ultrastable Mach-Zender interferometer by a polarizing beam splitter with variable polarizers to adjust the relative intensities in the signal and reference arms. The light scattering is performed in a back-scatter geometry because the intensity fluctuation rates depend on the momentum transfer vector that selects longitudinal motion along the backscatter direction. The light scattered by the living biological sample is collected by a long focal-length lens and transformed to a Fourier plane where the CCD pixel array is placed. The reference wave is incident on the CCD array at a small angle of 3 degrees relative to the signal axis, creating an off-axis digital hologram that is acquired on a Fourier plane of the optical imaging system. This Fourier-domain hologram is transformed using an FFT algorithm into the image domain. The transformation performs two functions: demodulating the spatial carrier frequency represented by the holographic interference fringes, and coherence-gating the low-coherence light to a specified depth inside the tissue sample. The coherence-gating role of digital holography creates a full-frame optical coherence tomography (OCT) section of the tumor spheroid at a fixed depth. Successive frames are acquired at a fixed coherence-gated depth at a frame rate of 25 fps.

The reconstructed images includes speckle intensities that are modulated by the dynamic intracellular motion of the target, causing intensity fluctuations on each pixel. The fluctuating intensities of the speckle images have characteristic time scales that relate to the specific types of intracellular motion inside the living tissue samples. When there are many processes and many different characteristic times, the frequency domain is best suited to analyze the influence of applied drugs on dynamic light scattering. The time-traces of the fluctuating intensities are transformed into the frequency domain as a spectral power density denoted by S(ω). The measured power spectrum is affected by the frame rate of the acquisition and by the exposure time of the shutter.

When a drug is applied to the sample, or the environmental conditions change, the relative power density at different frequencies is altered. This change is captured through the differential relative spectral power density. An example of a differential relative spectrogram is shown in FIG. 4A for the Raf kinase inhibitor Sorafenib applied to a DLD1 tumor spheroid. This spectrogram is a time-frequency representation of the relative changes in the spectral power after a drug is applied at time t=0. The frequency axis is logarithmic and extends from 0.005 Hz to 12.5 Hz. The time axis in this figure extends for 9 hours after the application of the dose at time t₀. The color map shows the relative increase/decrease of spectral power in response to the drug.

The two-dimensional time-frequency data format for each drug is decomposed into feature values that become the coordinates of a high-dimensional feature vector. The composition is not unique, but one quasi-orthogonal choice of twelve feature masks is shown in FIG. 4B. These are multiplied by the spectrogram in FIG. 4A and integrated to yield a single value for each mask. The twelve feature values are the components of the twelve-dimensional feature vector shown in FIG. 4C for the spectrogram of FIG. 4A. This procedure is carried out for each drug. The spectrograms are averaged in triplicate for each drug to reduce variability.

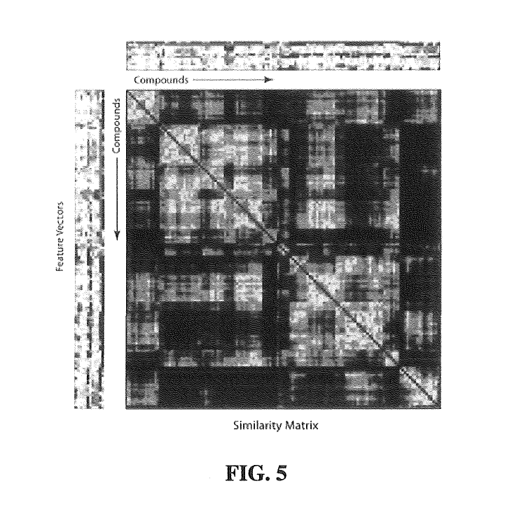

Tissue dynamic spectroscopy was performed on 140 different drugs, doses and conditions. Time-frequency tissue-response spectrograms were generated in each case and decomposed into feature vectors using the feature masks of FIG. 4B. A similarity matrix among the different feature vectors was generated through correlation, and was input into an unsupervised hierarchical clustering algorithm. The clustered similarity matrix and feature vectors are shown in FIG. 5. Subgroups of spectrograms share common features that are different than other subgroups, which is reflected in the quasi-block-diagonal character of the similarity matrix. Further details of the procedure utilized in these experiments and in the methods disclosed herein are disclosed in co-pending application Ser. No. 13/760,827, entitled “System and Method for Determining Modified States of Health of Living Tissue”, which was filed on Feb. 26, 2013, and was published on Jun. 6, 2013 as Pub. No. 2013/0144151, the entire disclosure of which is incorporated herein by reference.

High-Content Analysis Experiments

HCA of mitochondrial toxicity was performed [83] using live DLD-1 and HT-29 cell cultures stained with three fluorescent dyes: TMRM, Hoechst33342, and TO-PRO-3 (Invitrogen, Carlsbad, Calif.). The lipophilic cationic dye TMRM was used to monitor mitochondrial membrane potential (MMP). The cell-permeable nuclear marker Hoechst33342 was used to identify cell events and to monitor nuclear morphology. The membrane-impermeable nuclear marker TO-PRO-3 was used to characterize cell viability based on plasma membrane integrity. Detailed mitochondrial toxicity HCA with data collection and analysis protocols were recently described [80] and are briefly summarized here. Following a four hour incubation of cells with the tool compounds, a cocktail of the three fluorescent dyes was added, and cultures were incubated for an additional 45 min at 37° and 5% CO₂ before analysis. The final concentrations of dyes in each of 96 wells were 125 nM TMRM, 133 nM TO-PRO-3, and 1.5 μg/ml Hoechst33342. Along with the dyes, 20 μM Verapamil was added to the cocktail to maintain consistent TMRM cell loading through multi-drug inhibition. Liquid handling was performed using a BioMek FX Laboratory Automation Workstation (Beckman Coulter). Data were collected using an imaging cytometer iCys (Compucyte) configured with three excitation lasers (405 nm, 488 nm, 633 nm) and four emission detector PMTs. TMRM emission was recorded using a PMT with a 580/30 band-pass filter, Hoechst33342 with a 463/39 filter, and TO-PRO-3 with a 650 long-pass (LP) filter. Six fields of view (500×368.6 μm each) were arbitrarily collected per well using a 20× objective at 0.5 μm resolution.

Image segmentation was performed based on Hoechst33342 intensity using the iCysCytometric Analysis software (CompuCyte corp., Westwood, Mass.) to identify cell events. Primary contours were defined on the basis of adjacent Hoechst33342 pixels above the preset intensity threshold value (3500 a.u. for DLD1 cell line and 7900 a.u. for HT29) and expanded by four pixels for the analysis. A low pass 5×5 smoothing filter and watershed algorithm were applied to separate closely-spaced nuclei. Additionally, an area filter was applied to eliminate clumps with areas larger than 250 μm² and cell debris with areas less than 20 μm². Peripheral contours were defined as a 14 pixel-width ring outside the expanded primary contour. Integrated TMRM intensity within the peripheral contour (TMRM PI) and maximum TMRM pixel intensity within the peripheral contour (TMRM max) were selected as TMRM-based parameters. Nuclear area, nuclear circularity, nuclear average and integral intensities were used as Hoechst33342-based parameters. TO-PRO-3 average intensity was used as a viability measure.

After image feature extraction, statistical analysis of the population distribution was performed using Matlab 7.12.0 (The MathWorks). Kolmogorov-Smirnov (KS) values were used as statistical measures for TMRM- and Hoechst-based parameters. KS values were computed for each compound, dilution, and parameter of interest as

KS(comp,dmso)=max(cdf_{comp}-cdf_{dmso}),

where cdf is the cumulative distribution function of compound-treated and DMSO-treated (untreated) negative control samples respectively. The sign of KS reflects the direction of the shift of the distribution relative to the negative control (DMSO). Percentage of live cells (viability factor) was evaluated on TO-PRO-3-derived parameters. The viability factor was rescaled from −1 (all dead) to +1 (all live) to match the range for KS values.

Statistical measures of seven parameters (TMRM PI, TMRM max pix, nuclear area, circularity, average and total intensity, and cell viability) measured at three different concentrations (100 μM, 33.3 μM, 11.1 μM) for both cell lines were concatenated to create 21-parameter numerical vectors for phenotypic cell response characterization. Each experiment was performed in duplicates or quadruplicates and the obtained vectors were analyzed individually to evaluate statistical variability.

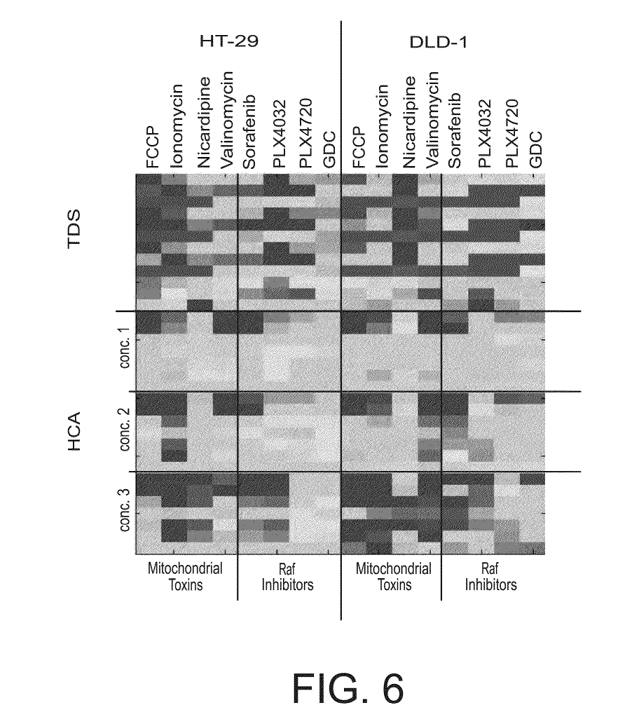

As an example of the HCA dataset and analysis, DLD1 cells were incubated for four hours with 100 μM of different compounds including vehicle negative control DMSO (no treatment). Cells were stained with a cell marker cocktail including three fluorescent dyes: Hoechst33342, TMRM and ToPro3 and analyzed with iCys imaging cytometer. Arbitrary images (500×368 μm) demonstrate a light-scatter channel, individual fluorescence channels for each cell marker and a merged channels with combination of all three fluorescence channels (color image). Examples of DLD1 responses to all 8 tested compounds and non-treated control (DMSO) are demonstrated in FIG. 6. The high-content (HCA) values for cellular morphology and fluorescent intensities were collected into feature vectors for three concentrations (11.1 μM, 33.3 μM, and 100 μM). The non-parametric Kolmogorov-Smirnoff test was used as the measure of HCA vector similarity.

Application of the Method

Density Matrix Projection Operator

The first step in the method is the construction of a joint feature vector data format in which the TDS and the HCA feature vectors are concatenated for each of the tested compounds and cell lines. The joint concatenated feature vectors are shown in FIG. 6 for 16 compound/cell-line combinations. The HCA data includes the top three concentrations, while the TDS feature vectors are at a single concentration.

As discussed above, the density operator \hat{p}_{b}^{a} is the outer product of the HCA and TDS feature vectors of a given compound m. The reduced density operator is the partial trace over a large set of M compounds, which is equivalent to calculating the correlation coefficients between each of the seven HCA and twelve TDS features in the present example.

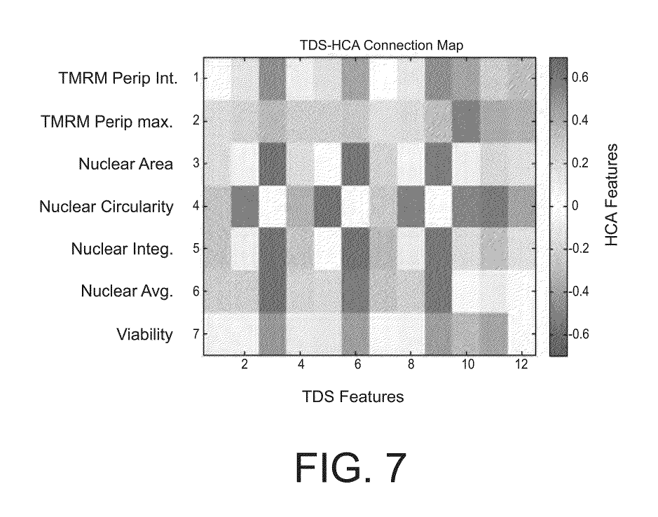

The translation matrix according to the present disclosure that is obtained from the joint feature vectors of FIG. 6, is shown in FIG. 7. The translation matrix is averaged over both cell lines (DLD-1 and HT-29) and averaged over all eight compounds (four mitochondrial toxins and four Raf inhibitors). The values of the matrix represent the correlations that exist among the TDS and HCA features. In this example, the vertical axis corresponds to the seven HCA features while the horizontal axis corresponds to the twelve TDS features of their respective feature vectors. Both strong positive correlation and strong negative correlation represent nearly one-to-one correspondence between the TDS and HCA features. For instance, the strongest positive correlations are between the mid-high TDS frequencies (TDS features 1, 2, 4, 5, 7 and 8) and mitochondrial polarization (TMRM signals) (HCA features 1 and 2). The strongest negative correlations are between the TDS high frequencies (TDS features 10, 11 and 12) and nuclear morphology and permeability (HCA features 3, 4 and 5). From previous studies, it is known that the high-frequency band in the TDS spectrograms relates to the activated motion of mitochondria. Strong mitochondrial polarization is seen here to correlate with strong mid-high frequencies in the spectrograms associated with organelles. Similarly, degraded nuclear morphology and nuclear membrane permeability known to be related to cell death correlates here with diminished high-frequencies in the spectrograms. These trends are also consistent with the strong negative correlation between viability and organelle transport observed in FIG. 6. The weakest correlations are seen for the HCA nuclear average and for the TDS f2t2 band.

Experimental Back-Projection and Fidelity

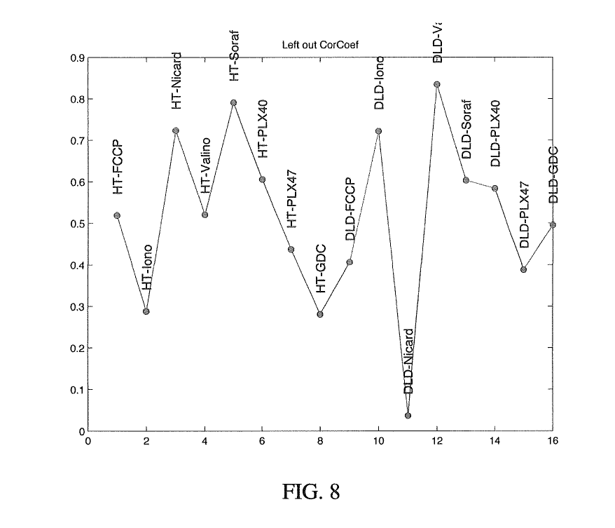

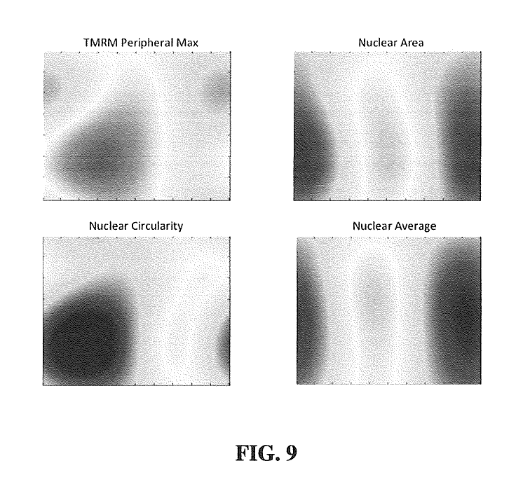

The projection from TDS back to HCA is tested by calculating the correlation between the original HCA vector and the back-projected HCA vector that is obtained by applying T_{q}^{p} to the TDS feature vectors. This procedure is performed in a “leave-one-out” process in which the translation matrix is constructed of 15 out of the 16 drug/cell line combinations (i.e., 8 drugs compounds for two cell lines). The condition that is left out is then the test TDS vector that is translated into an equivalent HCA vector. The actual HCA vector is compared to the translated HCA vector and the correlation coefficient is calculated. The results of the leave-one-out correlation analysis are shown in FIG. 8. Correlation coefficients larger than 0.5 are significant for this set M=16 of conditions. There are ten conditions that have significant correlations (HT-FCCP, HT-Nicardipine, HT-Valinomycin, HT-Sorafenib, HT-PLX4032, DLD Ionomycin, DLD-Valinomycin, DLD-Sorafenib, DLD-PLX4032, DLD-GDC) There are six conditions that do not have strong correlations (HT-Ionomycin, HT-PLX4720, HTGDC, DLD-FCCP, DLD-Nicardipine, DLD-PLX47-20).

The agreement demonstrated in FIG. 8 between mitochondrial signatures in TDS (high frequency bands) and mitochondrial membrane polarization is an important step in the characterization and calibration of TDS as a new type of phenotypic profiling that can operate in three-dimensional tissue. The importance of 3D tissues is growing in early drug screening, but there has been a lack of observational tools that can penetrate and obtain high-content information from inside living tissue without the need for fluorescent labeling. Tissue dynamics spectroscopy may be able to fill that need as the methods disclosed herein are applied to more extensive sets of drug classes and cell lines.

TDS Morphological Fingerprints

Each row of the translation matrix T_{q}^{p} contains a linear superposition of all TDS features. This makes it possible to define a TDS feature mask that contains the time-frequency features that correlate most strongly with each HCA property. This is expressed as

M^{p}(ω,t)=Σ_{q}T_{q}^{p}M^{q}(ω,t)

where M^{q} (ω,t) is the q^{th} TDS feature mask. Examples of the linear superpositions are shown in FIG. 9 for four of the HCA properties. Note that these masks are not orthogonal. For instance, the TMRM peripheral max is strongly anti-correlated with nuclear circularity. On the other hand, nuclear area and nuclear average are extremely similar, indicating that they measure essentially the same features from TDS.

The resulting masks M^{p} (ω,t) can subsequently be used as their own feature masks to generate pseudo-HCA feature vectors based on TDS datasets. The p-th HCA feature is obtained from a time-frequency TDS spectrogram S(ω,t) by

$$\vert {V}_{m}^{p} 〉 = \frac{{\sum }_{j = 1}^{T} {\sum }_{k = 1}^{F} {M}^{p} ( {ω}_{k} , {ω}_{j} ) {S}_{m} ( {ω}_{k} , {ω}_{j} )}{\sqrt{{\sum }_{j = 1}^{T} {\sum }_{k = 1}^{F} \vert {M}^{p} ( {ω}_{k} , {ω}_{j} ) {\vert}^{2}}}$$

where the pseudo-HCA feature value is normalized by the modulus of the mask M^{p} (ω,t). This aspect of the disclosed method takes an experimental TDS spectrogram as an input, matches that spectrogram with patterns that have an HCA context, provides a mechanistic means to interpret TDS datasets, and generates data in a format that can be used in established workflows that operate on HCA data. Because TDS data are obtained from 3D tissues that have greater biological relevance, this method can provide valuable and more reliable information to researchers in many areas in the life sciences.

Those skilled in the art will recognize that numerous modifications can be made to the specific implementations described above. The implementations should not be limited to the particular limitations described and described in the claims provided below. Other implementations may be possible.

### APPENDIX

### References

[1] K. A. Giuliano, J. R. Haskins, and D. L. Taylor, “Advances in high content screening for drug discovery,” Assay and Drug Development Technologies, vol. 1, pp. 565-577, August 2003.
[2] P. Denner, J. Schmalowsky, and S. Prechtl, “High-content analysis in preclinical drug discovery,” Combinatorial Chemistry & High Throughput Screening, vol. 11, pp. 216-230, March 2008.
[3] P. D. Caie, R. E. Walls, A. Ingleston-Orme, S. Daya, T. Houslay, R. Eagle, M. E. roberts, and N. O. Carragher, “High-Content Phenotypic Profiling of Drug Response Signatures across Distinct Cancer Cells,” Molecular Cancer Therapeutics, vol. 9, pp. 1913-1926, June 2010.
[4] D. W. Young, A. Bender, J. Hoyt, E. McWhinnie, G. W. Chirp, C. Y. Tao, J. A. Tallarico, M. Labow, J. L. Jenkins, T. J. Mitchison, and Y. Feng, “Integrating high-content screening and ligand-target prediction to identify mechanism of action,” Nature Chemical Biology, vol. 4, pp. 59-68, January 2008.
[5] K. A. Giuliano, “High-content profiling of drug-drug interactions: Cellular targets involved in the modulation of microtubule drug action by the antifungal ketoconazole,” Journal Of Biomolecular Screening, vol. 8, pp. 125-135, April 2003.
[6] S. Ohnuki, S. Oka, S. Nogami, and Y. Ohya, “High-Content, Image-Based Screening for Drug Targets in Yeast,” Plos One, vol. 5, Apr. 14, 2010.
[7] D. Thomas, J. Cortes, F. Giles, S. Faderl, S. O'Brien, M. B. Rios, J.-P. Issa, G. Garcia-Manero, C. Koller, R. Capdeville, M. Talpaz, and H. Kantarjian, “Combination of hyper-CVAD with imatinib mesylate (STI571) for Philadelphia (PH)-positive adult acute lymphocytic leukemia or chronic myelogenous leukemia in lymphoid blast phase,” Blood, vol. 98, p. 803a, 2001.
[8] H. Kantarjian, C. Sawyers, A. Hochhaus, F. Guilhot, C. Schiffer, C. Gambacorti-Passerini, D. Niederwieser, D. Resta, R. Capdeville, U. Zoellner, M. Talpaz, and B. Druker, “Hematologic and cytogenetic responses to imatinib mesylate in chronic myelogenous leukemia,” N Engl J Med, vol. 346, pp. 645-52, 2002.
[9] D. C. Swinney and J. Anthony, “How were new medicines discovered?,” Nature Reviews Drug Discovery, vol. 10, pp. 507-519, July 2011.
[10] P. J. Keller, F. Pampaloni, and E. H. K. Stelzer, “Life sciences require the third dimension,” Current Opinion In Cell Biology, vol. 18, pp. 117-124, February 2006.
[11] E. Cukierman, R. Pankov, D. R. Stevens, and K. M. Yamada, “Taking cell-matrix adhesions to the third dimension,” Science, vol. 294, pp. 1708-1712, Nov. 23, 2001.
[12] W. MuellerKlieser, “Three-dimensional cell cultures: from molecular mechanisms to clinical applications,” American Journal Of Physiology-Cell Physiology, vol. 273, pp. C1109-C1123, October 1997.
[13] P. Friedl and E. B. Brocker, “The biology of cell locomotion within three-dimensional extracellular matrix,” Cellular and Molecular Life Sciences, vol. 57, pp. 41-64, Jan. 20, 2000.
[14] T. Jacks and R. A. Weinberg, “Taking the study of cancer cell survival to a new dimension,” Cell, vol. 111, pp. 923-925, Dec. 27, 2002.
[15] J. B. Kim, “Three-dimensional tissue culture models in cancer biology,” Seminars in Cancer Biology, vol. 15, pp. 365-377, October 2005.
[16] K. S. M. Smalley, M. Lioni, and M. Herlyn, “Life isn't flat: Taking cancer biology to the next dimension,” In Vitro Cellular & Developmental Biology-Animal, vol. 42, pp. 242-247, September-October 2006.
[17] J. T. Erler and V. M. Weaver, “Three-dimensional context regulation of metastasis,” Clinical & Experimental Metastasis, vol. 26, pp. 35-49, January 2009.
[18] J. A. Pedersen and M. A. Swartz, “Mechanobiology in the third dimension,” Annals Of Biomedical Engineering, vol. 33, pp. 1469-1490, November 2005.
[19] G. Y. Lee, P. A. Kenny, E. H. Lee, and M. J. Bissell, “Three-dimensional culture models of normal and malignant breast epithelial cells,” Nature Methods, vol. 4, pp. 359-365, April 2007.
[20] T. Gudjonsson, L. Ronnov-Jessen, R. Villadsen, M. J. Bissell, and O. W. Petersena, “To create the correct microenvironment: three-dimensional heterotypic collagen assays for human breast epithelial morphogenesis and neoplasia,” Methods, vol. 30, pp. 247-255, July 2003.
[21] F. Pampaloni, E. G. Reynaud, and E. H. K. Stelzer, “The third dimension bridges the gap between cell culture and live tissue,” Nature Reviews Molecular Cell Biology, vol. 8, pp. 839-845, October 2007.
[22] A. Abbott, “Cell culture Biology's new dimension,” Nature, vol. 424, pp. 870-872, 2003.
[23] N. A. L. Cody, M. Zietarska, A. Filali-Mouhim, D. M. Provencher, A. M. Mes-Masson, and P. N. Tonin, “Influence of monolayer, spheroid, and tumor growth conditions on chromosome 3 gene expression in tumorigenic epithelial ovarian cancer cell lines,” Bmc Medical Genomics, vol. 1, Aug. 7, 2008.
[24] T. T. Chang and M. Hughes-Fulford, “Monolayer and Spheroid Culture of Human Liver Hepatocellular Carcinoma Cell Line Cells Demonstrate Distinct Global Gene Expression Patterns and Functional Phenotypes,” Tissue Engineering Part A, vol. 15, pp. 559-567, March 2009.
[25] L. Gaedtke, L. Thoenes, C. Culmsee, B. Mayer, and E. Wagner, “Proteomic analysis reveals differences in protein expression in spheroid versus monolayer cultures of low-passage colon carcinoma cells,” Journal of Proteome Research, vol. 6, pp. 4111-4118, November 2007.
[26] D. Barbone, T. M. Yang, J. R. Morgan, G. Gaudino, and V. C. Broaddus, “Mammalian target of rapamycin contributes to the acquired apoptotic resistance of human mesothelioma multicellular spheroids,” Journal Of Biological Chemistry, vol. 283, pp. 13021-13030, May 9, 2008.
[27] A. L. Howes, G. G. Chiang, E. S. Lang, C. B. Ho, G. Powis, K. Vuori, and R. T. Abraham, “The phosphatidylinositol 3-kinase inhibitor, PX-866, is a potent inhibitor of cancer cell motility and growth in three-dimensional cultures,” Molecular Cancer Therapeutics, vol. 6, pp. 2505-2514, September 2007.
[28] A. Frankel, S. Man, P. Elliott, J. Adams, and R. S. Kerbel, “Lack of multicellular drug resistance observed in human ovarian and prostate carcinoma treated with the proteasome inhibitor PS-341,” Clinical Cancer Research, vol. 6, pp. 37193728, September 2000.
[29] J. Poland, P. Sinha, A. Siegert, M. Schnolzer, U. Korf, and S. Hauptmann, “Comparison of protein expression profiles between monolayer and spheroid cell culture of HT-29 cells revealed fragmentation of CK18 in three-dimensional cell culture,” Electrophoresis, vol. 23, pp. 1174-1184, April 2002.
[30] N. Wang, J. P. Butler, and D. E. Ingber, “Mechanotransduction Across The Cell-Surface And Through The Cytoskeleton,” Science, vol. 260, pp. 1124-1127, May 21, 1993.
[31] C. S. Chen, M. Mrksich, S. Huang, G. M. Whitesides, and D. E. Ingber, “Geometric control of cell life and death,” Science, vol. 276, pp. 1425-1428, May 30, 1997.
[32] D. E. Ingber, “Cellular mechanotransduction: putting all the pieces together again,” Faseb Journal, vol. 20, pp. 811-827, May 2006.
[33] E. A. Swanson, D. Huang, M. R. Hee, J. G. Fujimoto, C. P. Lin, and C. A. Puliafito, “High-speed optical coherence domain reflectometry,” Opt. Lett., vol. 17, p. 151, 1992.
[34] A. F. Fercher, W. Drexler, C. K. Hitzenberger, and T. Lasser, “Optical coherence tomography—principles and applications,” Reports On Progress In Physics, vol. 66, pp. 239-303, February 2003.
[35] P. Yu, L. Peng, M. Mustata, J. J. Turek, M. R. Melloch, and D. D. Nolte, “Time-Dependent Speckle in Holographic Optical Coherence Imaging and the State of Health of Tumor Tissue,” Optics Letters, vol. 29, pp. 68-70, 2004.
[36] K. Jeong, J. J. Turek, and D. D. Nolte, “Imaging Motility Contrast in Digital Holography of Tissue Response to Cytoskeletal Anti-cancer Drugs” Optics Express, vol. 15, pp. 14057-14064, 2007.
[37] K. Jeong, J. J. Turek, and D. D. Nolte, “Speckle fluctuation spectroscopy of intracellular motion in living tissue using coherence-domain digital holography,” Journal of Biomedical Optics, vol. 15, p. 030514, May-June 2010.
[38] D. D. Nolte, R. An, J. Turek, and K. Jeong, “Holographic tissue dynamics spectroscopy,” Journal of Biomedical Optics, vol. 16, pp. 087004-13, August 2011.
[39] S. C. W. Hyde, R. Jones, N. P. Barry, J. C. Dainty, P. M. W. French, K. M. Kwolek, D. D. Nolte, and M. R. Melloch, “Depth-resolved holography through turbid media using photorefraction,” IEEE Journal of Selected Topics in Quantum Electronics, vol. 2, pp. 965-975, December 1996.
[40] P. Yu, M. Mustata, J. J. Turek, P. M. W. French, M. R. Melloch, and D. D. Nolte, “Holographic optical coherence imaging of tumor spheroids,” Applied Physics Letters, vol. 83, pp. 575-577, Jul. 21, 2003.
[41] M. Laubscher, M. Ducros, B. Karamata, T. Lasser, and R. Salathe, “Video-rate three-dimensional optical coherence tomography,” Optics Express, vol. 10, pp. 429-435, May 6, 2002.
[42] A. Dubois, K. Grieve, G. Moneron, R. Lecaque, L. Vabre, and C. Boccara, “Ultrahigh-resolution full-field optical coherence tomography,” Applied Optics, vol. 43, pp. 2874-2883, May 10, 2004.
[43] B. Karamata, M. Leutenegger, M. Laubscher, S. Bourquin, T. Lasser, and P. Lambelet, “Multiple scattering in optical coherence tomography. II. Experimental and theoretical investigation of cross talk in wide-field optical coherence tomography,” Journal of the Optical Society of America a-Optics Image Science and Vision, vol. 22, pp. 1380-1388, July 2005.
[44] S. C. W. Hyde, N. P. Barry, R. Jones, J. C. Dainty, and P. M. W. French, “Sub100 Micron Depth-Resolved Holographic Imaging Through Scattering Media in the Near-Infrared,” Optics Letters, vol. 20, pp. 2330-2332, 1995.
[45] D. D. Nolte, “Semi-insulating semiconductor heterostructures: Optoelectronic properties and applications,” J. Appl. Phys., vol. 85, pp. 6259-6289, 1999.
[46] I. Yamaguchi and T. Zhang, “Phase-shifting digital holography,” Optics Letters, vol. 22, pp. 1268-1270, Aug. 15, 1997.
[47] E. Cuche, F. Bevilacqua, and C. Depeursinge, “Digital holography for quantitative phase-contrast imaging,” Optics Letters, vol. 24, pp. 291-293, Mar. 1, 1999.
[48] F. Dubois, L. Joannes, and J. C. Legros, “Improved three-dimensional imaging with a digital holography microscope with a source of partial spatial coherence,” Applied Optics, vol. 38, pp. 7085-7094, Dec. 1, 1999.
[49] T. C. Poon, T. Yatagai, and W. Juptner, “Digital holography—coherent optics of the 21st century: introduction,” Applied Optics, vol. 45, pp. 821-821, Feb. 10, 2006.
[50] K. Jeong, J. J. Turek, and D. D. Nolte, “Fourier-Domain Digital Holographic Optical Coherence Imaging of Living Tissue,” Appl. Opt., vol. 46, pp. 49995008, 2007.
[51] G. Maret and P. E. Wolf, “Multiple Light-Scattering from Disordered Media—the Effect of Brownian-Motion of Scatterers,” Zeitschrift Fur Physik B-Condensed Matter, vol. 65, pp. 409-413, 1987.
[52] D. J. Pine, D. A. Weitz, P. M. Chaikin, and E. Herbolzheimer, “Diffusing-Wave Spectroscopy,” Physical Review Letters, vol. 60, pp. 1134-1137, Mar. 21, 1988.
[53] D. A. Boas and A. G. Yodh, “Spatially varying dynamical properties of turbid media probed with diffusing temporal light correlation,” Journal of the Optical Society of America a-Optics Image Science and Vision, vol. 14, pp. 192-215, January 1997.
[54] M. Suissa, C. Place, E. Goillot, and E. Freyssingeas, “Internal dynamics of a living cell nucleus investigated by dynamic light scattering,” European Physical Journal E, vol. 26, pp. 435-448, August 2008.
[55] C. Joo, C. L. Evans, T. Stepinac, T. Hasan, and J. F. de Boer, “Diffusive and directional intracellular dynamics measured by field-based dynamic light scattering,” Optics Express, vol. 18, pp. 2858-2871, Feb. 1, 2010.
[56] S. H. Chen and F. R. Hallett, “Determination of Motile Behavior of Prokaryotic and Eukaryotic Cells by Quasi-Elastic Light-Scattering,” Quarterly Reviews of Biophysics, vol. 15, pp. 131-222, 1982.
[57] R. B. Tishler and F. D. Carlson, “A Study of the Dynamic Properties of the Human Red-Blood-Cell Membrane Using Quasi-Elastic Light-Scattering Spectroscopy,” Biophysical Journal, vol. 65, pp. 2586-2600, December 1993.
[58] A. Palmer, T. G. Mason, J. Y. Xu, S. C. Kuo, and D. Wirtz, “Diffusing wave spectroscopy microrheology of actin filament networks,” Biophysical Journal, vol. 76, pp. 1063-1071, February 1999.
[59] M. Heckmeier, S. E. Skipetrov, G. Maret, and R. Maynard, “Imaging of dynamic heterogeneities in multiple-scattering media,” Journal of the Optical Society of America a-Optics Image Science and Vision, vol. 14, pp. 185-191, January 1997.
[60] J. Li, G. Dietsche, D. Iftime, S. E. Skipetrov, G. Maret, T. Elbert, B. Rockstroh, and T. Gisler, “Noninvasive detection of functional brain activity with near-infrared diffusing-wave spectroscopy,” Journal of Biomedical Optics, vol. 10, pp. 044002-1 to 044002-12, July-August 2005.
[61] R. M. Sutherland, “Cell and environment interactions in tumor microregions—The multicell spheroid model,” Science, vol. 240, pp. 177-184, April 1988.
[62] L. A. Kunz-Schughart, J. P. Freyer, F. Hofstaedter, and R. Ebner, “The use of 3-D cultures for high-throughput screening: The multicellular spheroid model,” Journal Of Biomolecular Screening, vol. 9, pp. 273-285, June 2004.
[63] J. Friedrich, R. Ebner, and L. A. Kunz-Schughart, “Experimental anti-tumor therapy in 3-D: Spheroids—old hat or new challenge?,” International Journal of Radiation Biology, vol. 83, pp. 849-871, 2007.
[64] S. Nadanaciva and Y. Will, “Current concepts in drug-induced mitochondrial toxicity,” Chap. 2 in Current Protocols in Toxicology M. D. Maines, Ed., ed, 2009, p. Unit 2.15.
[65] K. E. Miller and M. P. Sheetz, “Axonal mitochondrial transport and potential are correlated,” Journal of Cell Science, vol. 117, pp. 2791-2804, June 2004.
[66] Z. Li, K. Okamoto, Y. Hayashi, and M. Sheng, “The importance of dendritic mitochondria in the morphogenesis and plasticity of spines and synapses,” Cell, vol. 119, pp. 873-887, December 2004.
[67] J. Kolikova, R. Afzalov, A. Giniatullina, A. Surin, R. Giniatullin, and L Khiroug, “Calcium-dependent trapping of mitochondria near plasma membrane in stimulated astrocytes,” Brain Cell Biology, vol. 35, pp. 75-86, February 2006.
[68] E. Kremneva, M. Kislin, X. Kang, and L Khiroug, “Motility of astrocytic mitochondria is arrested by Ca2+-dependent interaction between mitochondria and actin filaments,” Cell Calcium, vol. 53, pp. 85-93, February 2013.
[69] E. Vakiani and D. B. Solit, “KRAS and BRAF: drug targets and predictive biomarkers,” Journal Of Pathology, vol. 223, pp. 219-229, January 2011 2011.
[70] H. Davies, G. R. Bignell, C. Cox, P. Stephens, S. Edkins, S. Clegg, J. Teague, H. Woffendin, M. J. Garnett, W. Bottomley, N. Davis, N. Dicks, R. Ewing, Y. Floyd, K. Gray, S. Hall, R. Hawes, J. Hughes, V. Kosmidou, A. Menzies, C. Mould, A. Parker, C. Stevens, S. Watt, S. Hooper, R. Wilson, H. Jayatilake, B. A. Gusterson, C. Cooper, J. Shipley, D. Hargrave, K. Pritchard-Jones, N. Maitland, G. Chenevix-Trench, G. J. Riggins, D. D. Bigner, G. Palmieri, A. Cossu, A. Flanagan, A. Nicholson, J. W. C. Ho, S. Y. Leung, S. T. Yuen, B. L. Weber, H. F. Siegler, T. L. Darrow, H. Paterson, R. Marais, C. J. Marshall, R. Wooster, M. R. Stratton, and P. A. Futreal, “Mutations of the BRAF gene in human cancer,” Nature, vol. 417, pp. 949-954, Jun. 27, 2002.
[71] M. S. Brose, P. Volpe, M. Feldman, M. Kumar, I. Rishi, R. Gerrero, E. Einhorn, M. Herlyn, J. Minna, A. Nicholson, J. A. Roth, S. M. Albelda, H. Davies, C. Cox, G. Brignell, P. Stephens, P. A. Futreal, R. Wooster, M. R. Stratton, and B. L. Weber, “BRAF and RAS mutations in human lung cancer and melanoma,” Cancer Research, vol. 62, pp. 6997-7000, December 2002.
[72] W. S. Samowitz, C. Sweeney, J. Herrick, H. Albertsen, T. R. Levin, M. A. Murtaugh, R. K. Wolff, and M. L. Slattery, “Poor survival associated with the BRAF V600E mutation in microsatellite-stable colon cancers,” Cancer Research, vol. 65, pp. 6063-6070, July 2005.
[73] T. Eisen, T. Ahmad, K. T. Flaherty, M. Gore, S. Kaye, R. Marais, I. Gibbens, S. Hackett, M. James, L. M. Schuchter, K. L. Nathanson, C. Xia, R. Simantov, B. Schwartz, M. Poulin-Costello, P. J. O'Dwyer, and M. J. Ratain, “Sorafenib in advanced melanoma: a Phase II randomised discontinuation trial analysis,” British Journal of Cancer, vol. 95, pp. 581-586, September 2006.
[74] K. T. Flaherty, “Sorafenib in renal cell carcinoma,” Clinical Cancer Research, vol. 13, pp. 747S-752S, January 2007.
[75] J. Tsai, J. T. Lee, W. Wang, J. Zhang, H. Cho, S. Mamo, R. Bremer, S. Gillette, J. Kong, N. K. Haass, K. Sproesser, L. Li, K. S. M. Smalley, D. Fong, Y. L. Zhu, A. Marimuthu, H. Nguyen, B. Lam, J. Liu, I. Cheung, J. Rice, Y. Suzuki, C. Luu, C. Settachatgul, R. Shellooe, J. Cantwell, S. H. Kim, J. Schlessinger, K. Y. J. Zhang, B. L. West, B. Powell, G. Habets, C. Zhang, P. N. Ibrahim, P. Hirth, D. R. Artis, M. Herlyn, and G. Bollag, “Discovery of a selective inhibitor of oncogenic B-Raf kinase with potent antimelanoma activity,” Proceedings Of The National Academy Of Sciences Of The United States Of America, vol. 105, pp. 3041-3046, Feb. 26, 2008.
[76] E. W. Joseph, C. A. Pratilas, P. I. Poulikakos, M. Tadi, W. Wang, B. S. Taylor, E. Halilovic, Y. Persaud, F. Xing, A. Viale, J. Tsai, P. B. Chapman, G. Bollag, D. B. Solit, and N. Rosen, “The RAF inhibitor PLX4032 inhibits ERK signaling and tumor cell proliferation in a V600E BRAF-selective manner,” Proceedings Of The National Academy Of Sciences Of The United States Of America, vol. 107, pp. 14903-14908, Aug. 17, 2010 2010.
[77] G. Bollag, P. Hirth, J. Tsai, J. Zhang, P. N. Ibrahim, H. Cho, W. Spevak, C. Zhang, Y. Zhang, G. Habets, E. Burton, B. Wong, G. Tsang, B. L. West, B. Powell, R. Shellooe, A. Marimuthu, H. Nguyen, K. Y. J. Zhang, D. R. Artis, J. Schlessinger, F. Su, B. Higgins, R. Iyer, K. D'Andrea, A. Koehler, M. Stumm, P. S. Lin, R. J. Lee, J. Grippo, I. Puzanov, K. B. Kim, A. Ribas, G. A. McArthur, J. A. Sosman, P. B. Chapman, K. T. Flaherty, X. Xu, K. L. Nathanson, and K. Nolop, “Clinical efficacy of a RAF inhibitor needs broad target blockade in BRAF-mutant melanoma,” Nature, vol. 467, pp. 596-599, September 2010 2010.
[78] K. T. Flaherty, I. Puzanov, K. B. Kim, A. Ribas, G. A. McArthur, J. A. Sosman, P. J. O'Dwyer, R. J. Lee, J. F. Grippo, K. Nolop, and P. B. Chapman, “Inhibition of Mutated, Activated BRAF in Metastatic Melanoma,” New England Journal of Medicine, vol. 363, pp. 809-819, Aug. 26, 2010.
[79] G. Hatzivassiliou, K. Song, I. Yen, B. J. Brandhuber, D. J. Anderson, R. Alvarado, M. J. C. Ludlam, D. Stokoe, S. L. Gloor, G. Vigers, T. Morales, I. Aliagas, B. Liu, S. Sideris, K. P. Hoeflich, B. S. Jaiswal, S. Seshagiri, H. Koeppen, M. Belvin, L. S. Friedman, and S. Malek, “RAF inhibitors prime wild-type RAF to activate the MAPK pathway and enhance growth,” Nature, vol. 464, pp. 431-U132, Mar. 18, 2010.
[80] P. I. Poulikakos, C. Zhang, G. Bollag, K. M. Shokat, and N. Rosen, “RAF inhibitors transactivate RAF dimers and ERK signaling in cells with wild-type BRAF,” Nature, vol. 464, pp. 427-U126, Mar. 18, 2010.
[81] F. M. Kaplan, Y. Shao, M. M. Mayberry, and A. E. Aplin, “Hyperactivation of MEK-ERK1/2 signaling and resistance to apoptosis induced by the oncogenic BRAF inhibitor, PLX4720, in mutant N-RAS melanoma cells,” Oncogene, vol. 30, pp. 366-371, January 2011.
[82] K. P. Hoeflich, S. Herter, J. Tien, L. Wong, L. Berry, J. Chan, C. O'Brien, Z. Modrusan, S. Seshagiri, M. Lackner, H. Stern, E. Choo, L. Murray, L. S. Friedman, and M. Belvin, “Antitumor Efficacy of the Novel RAF Inhibitor GDC0879 Is Predicted by BRAF(V600E) Mutational Status and Sustained Extracellular Signal-Regulated Kinase/Mitogen-Activated Protein Kinase Pathway Suppression,” Cancer Research, vol. 69, pp. 3042-3051, April 2009.
83] R. An, D. Merrill, L. Avramova, J. Sturgis, M. Tsiper, J. P. Robinson, J. Turek, and D. D. Nolte, “Phenotypic Profiling of Raf Inhibitors and Mitochondrial Toxicity in 3D Tissue Using Biodynamic Imaging,” Journal Of Biomolecular Screening, vol. 19, pp. 526-537, April 2014.

1. A method for translating three-dimensional data obtained from a living biological specimen to high content analysis (HCA) data format, comprising:
obtaining a feature vector |Vₘ^{a}> for a first plurality of features of a specimen measured by high-content image analysis (HCA) across a plurality M of external perturbations to the specimen, where m=1 to M;
obtaining a feature vector |Vₘ^{b}> for a second plurality of features of the specimen measured by tissue dynamics spectroscopy (TDS) across the plurality M of external perturbations to the specimen;
generating a density matrix \hat{p}_{b}^{a} as the outer product of the HCA and TDS feature vectors for each perturbation m;
generating a translation matrix T_{q}^{p} as the partial trace of the density matrix for all perturbations M; and
for each perturbation m applying the translation matrix T_{q}^{p} to the associated TDS feature vector |Vₘ^{a}> to reconstruct a matrix of back-projected HCA feature vectors |Vₘ^{b}>; and
evaluating back-projected HCA feature vector matrix to assess the tissue response to the perturbations.

2. The method of claim 1, wherein:
the living biological specimen is a tumor; and
the plurality of perturbations are a plurality of different drug compounds.

3. The method of claim 1, wherein the TDS feature vector is generated by a set of time-frequency masks that operate on a tissue-response spectrogram.

4. The method of claim 3, wherein the time-frequency masks are matched to known biological functions.

5. The method of claim 3, wherein the time-frequency masks are quasi-orthogonal decompositions of the time-frequency plane.

6. The method of claim 1, further comprising:
comparing each original HCA feature vector with each corresponding back-generated HCA feature vector to determine a correlation coefficient for each of the plurality M of perturbations between the two feature vectors; and
evaluating the tissue response only to the perturbations having a correlation coefficient above a predetermined value.

7. The method of claim 4, wherein the predetermined value for the correlation coefficient is 0.5.

8. The method of claim 1, wherein the second plurality of features is greater in number than the first plurality of features.

9. The method of claim 1, wherein the first and second plurality of features include independent and dependent features between the two feature vectors.

10. A method for interpreting three-dimensional data obtained from a living biological specimen in terms of physiological tissue response, comprising:
obtaining a feature vector |Vₘ^{a}> for a first plurality of features of a specimen measured by high-content image analysis (HCA) across a plurality M of external perturbations to the specimen, where m=1 to M;
obtaining a feature vector |Vₘ^{b}> for a second plurality of features of the specimen measured by tissue dynamics spectroscopy (TDS) across the plurality M of external perturbations to the specimen;
generating a density matrix \hat{p}_{b}^{a} as the outer product of the HCA and TDS feature vectors for each perturbation m;
generating a translation matrix T_{q}^{p} as the partial trace of the density matrix for all perturbations M; and
constructing an artificial TDS spectrogram that is representative of at least one of the plurality of HCA features.

11. The method of claim 10, further comprising:
correlating the artificial TDS spectrogram with an experimental TDS spectrogram; and
evaluating the tissue response only for perturbations having correlation coefficient with a magnitude above a predetermined value.
